(19) United States
(12) Patent Application Publication
(10) Pub. No.: US 2004/0025151 A1
(43) Pub. Date: Feb. 5, 2004

(54) Method for improving instruction selection efficiency in a DSP/RISC compiler

(76) Inventor: Shan-Chyun Ku, Hsinchu (TW)

Correspondence Address: RABIN & Berdo, PC, 1101 14TH STREET, NW, SUITE 500, WASHINGTON, DC, 20005, US

(21) Appl. No.: 10/207,829

(22) Filed: Jul. 31, 2002

(51) Int. Cl. G06F 9/45; G06F 15/00

(52) U.S. Cl. 717/159; 712/35; 712/41; 717/140

(57) ABSTRACT

A method for improving instruction selection efficiency in a DSP/RISC compiler. Concurrently obtaining optimal performance and space, the method includes the following steps: determining a semantic tree for a basic block; finding all matching combinations for the semantic tree with reference to a set of patterns; determining cycle number and instruction length for all combinations; filtering the instruction length greater than a predetermined instruction length and extra ones having the same cycle number and instruction length according to the determined cycle number and instruction length; and choosing one combination with the smallest cycle number from the remaining combinations and outputting the one combination as the desired object code.

### BACKGROUND OF THE INVENTION

1. Field of the Invention

The invention relates to an instruction scheduling method, especially to a method for improving instruction selection efficiency in a DSP/RISC compiler, to concurrently obtain optimal performance and space.

2. Description of Related Art

FIG. 1 is the structure of a typical compiler. In FIG. 1, the structure includes a human-readable source code 11, a compiler 12 and a target object code 13. The compiler 12 further includes a front end 200, an optimizer 202, a grammar processor 204, a pattern table generator 206 and a code generator 208. As shown in FIG. 1, the front end 200 receives the human-readable source code 11 such as a source code written in C, C++, VB, or PASCAL high-level language (which may be stored in a storage device like internal memory or external hard disk) and perform a token analysis. The optimizer 202 translates the source code 11 to an optimized intermediate representation (IR). The grammar processor 204 performs a grammar analysis and the result is fed into a pattern table generator to obtain a set of pattern matching tables (PMTs). The code generator 208 outputs an object code 13 by performing semantic tree pattern matching according to the IL and PMTs. Those skilled in the art will recognize that the object code 13 may comprise either assembly code or binary code, as desired.

The IR includes a number of basic blocks. A basic block is a sequence of intermediate instructions with a single entry at the top and a single exit at the bottom. Each basic block may be represented as one or more independent data dependency graphs, each including one or more nodes. Each node generally represents an instruction which, when executed in a target machine (not shown), enables the target machine to perform a function associated with the instruction. In a data dependency graph, operation of a subsequent node may be dependent on dam generated and/or a variable created in a prior node (wherein the prior node is so named because it executes prior to the subsequent node). However, operation of the prior node is not dependent on data generated and/or a variable created in the subsequent node (unless a loop exists such that the subsequent node executes before the prior node).

Conventionally, the machine specific information (such as the identity of instructions, the latency of instructions, the number and type of registers utilized by instructions and the like) is embedded into compilers. Consequently, the optimizer 202 in the compiler 12 is machine-dependent. The machine-dependent optimizer 202 repeatedly executes instruction selection, register allocation and instruction reordering and parallelization. An example is given below to describe the difference between the prior art and the invention for the instruction selection on a semantic tree.

FIG. 2 is a graph of a basic block of an example and its semantic tree operated by the compiler of FIG. 1. As shown in FIG. 2, this example shows a basic block having an independent data dependency graph with an operation of pR0=abs(pb1−pR2)+abs(pR3−pR4) and its semantic tree, wherein pR0-4 are registers. To complete this semantic tree, the code generator 208 executes the tree pattern matching. The tree pattern matching is a bottom-top instruction selection operation performed before register allocation. As shown in FIG. 3, node registers pR5 and pR7 are first formed by respectively selecting a match pattern provided by the pattern table generator and then node registers pR6 and pR8 are formed in the same manner as the prior node registers. Finally, the desired semantic tree is completed when node register pR0 is formed and output by the code generator 208. However, a conventional compiler such as 12 of FIG. 1 has a problem providing optimal space utility and optimal performance concurrently. Generally, the optimal space utility is sacrificed. For example, the cited nodes pR6 and pR8 each can be obtained by two schemes in the optimizer 202. The first scheme shown in FIG. 4a uses a conditional instruction and a jump instruction whose execution needs 6 cycles. The first scheme results in a size of 2 instructions (space utility) and an average of 4 cycles (performance). The second scheme shown in FIG. 4b uses sign shift with 32 times, XOR and minus operations. The second scheme results in 3 instructions and 3 cycles. Thus, when the former is applied to optimize for space, it needs 11 cycles and 7 instructions shown in FIG. 5a. When the latter is applied to optimize for performance, it needs 9 cycles and 9 instructions shown in FIG. 5b. Accordingly, we can see that the performance and space utility are incompatible. As shown in FIG. 6, it presents a negative linear relationship (a line through points v, x) and has a better quality on lower-left (point a), worse quality on upper-right (point b). For example, when a user needs a space of 12K size, the user has to purchase a DSP capacity of 16K because the capacity of a DSP is grown by 2′, wherein n is an integer. This will waste ¼ of the 16K capacity. This problem is increasingly serious with the compiler application in development of a DSP/RISC system that is widely used in multimedia, especially in image processing.

### SUMMARY OF THE INVENTION

Accordingly, an object of the invention is to provide a method for improving instruction selection efficiency in a DSP/RISC compiler, to concurrently obtain optimal performance and space.

The invention provides a method for improving instruction selection efficiency in a DSP/RISC compiler, which determines an optimal code size within a limited space chosen by a user, thereby concurrently creating optimal performance and optimal space utility. The method includes the following steps: determining a semantic tree for a basic block; finding all matching combinations for the semantic tree with reference to a set of patterns; determining cycle number and instruction length for all combinations; filtering the instruction length greater than a predetermined instruction length and extra ones having the same cycle number and instruction length according to the determined cycle number and instruction length; and choosing one combination with the smallest cycle number from the remaining combinations and outputting the one combination to be desired object code.

### BRIEF DESCRIPTION OF THE DRAWINGS

FIG. 1 is the structure of a typical compiler;

FIG. 2 is a graph of a basic block example and its semantic tree;

FIG. 3 is a graph of the basic block example that has exploded by the compiler to all nodes on the semantic tree of FIG. 2;

FIG. 4a is a graph of a portion pattern of the semantic tree with a first instruction selection by the compiler;

FIG. 4b is a graph of the portion pattern of the semantic tree with a second instruction selection by the compiler;

FIG. 5a is a graph of the semantic tree that has completed by the first instruction selection of FIG. 4a;

FIG. 5b is a graph of the semantic tree that has completed by the second instruction selection of FIG. 4b;

FIG. 6 is a graph of the cycle-to-space curve of FIG. 2;

FIG. 7 is a flowchart of the method for improving instruction selection efficiency in a DSP/RISC compiler according to the invention;

FIG. 8 is an example of a set of patterns for the basic block example in FIG. 2 according to the invention;

FIG. 9 is a graph of the semantic tree that has completed by a third instruction selection according to the invention;

FIG. 10 is an example of describing the result after the algorithm is performed according to the invention; and

FIG. 11 is a graph of the cycle-to-space curve according to the invention.

### DETAILED DESCRIPTION OF THE INVENTION

The following numbers denote the same elements throughout the description and drawings.

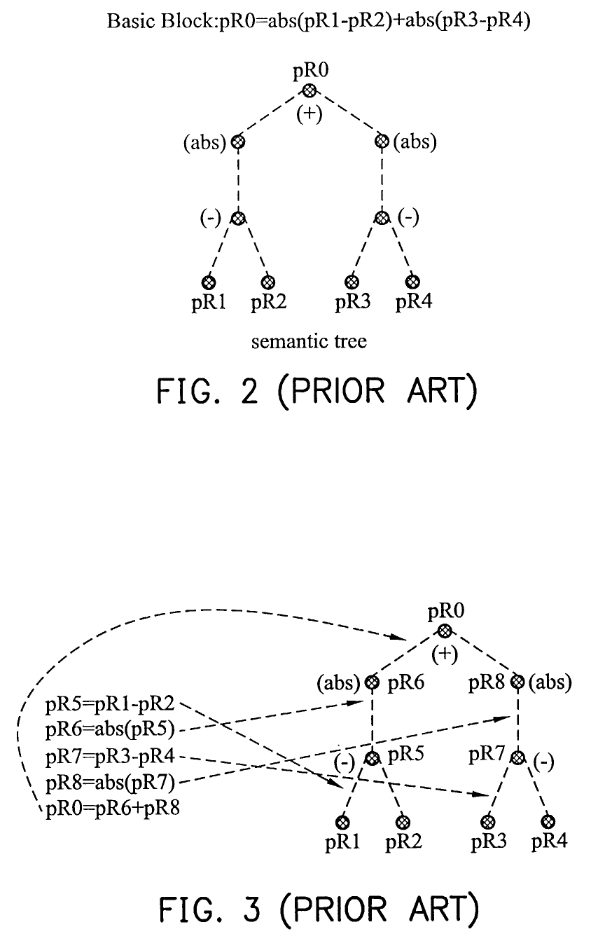

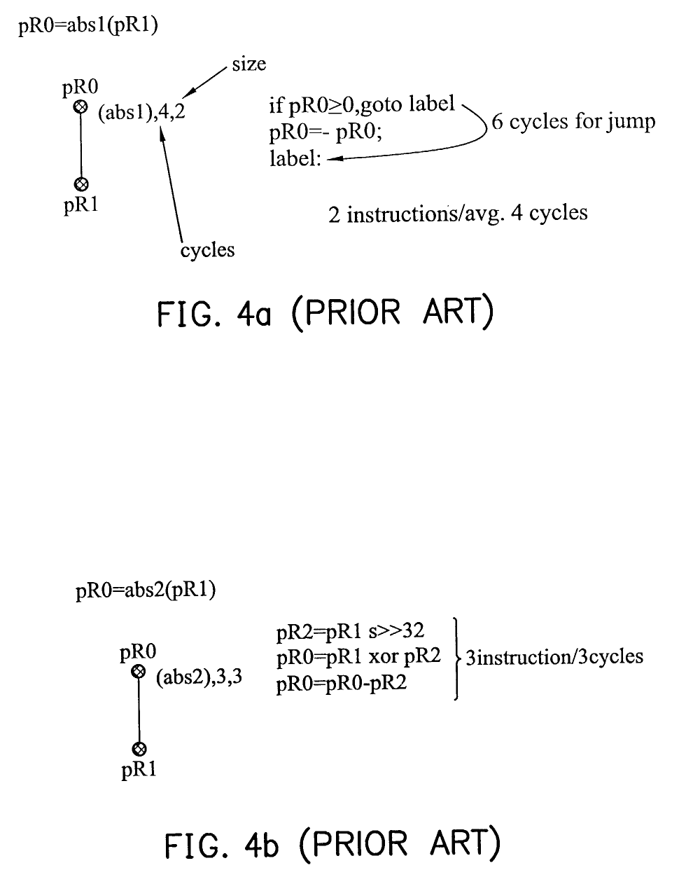

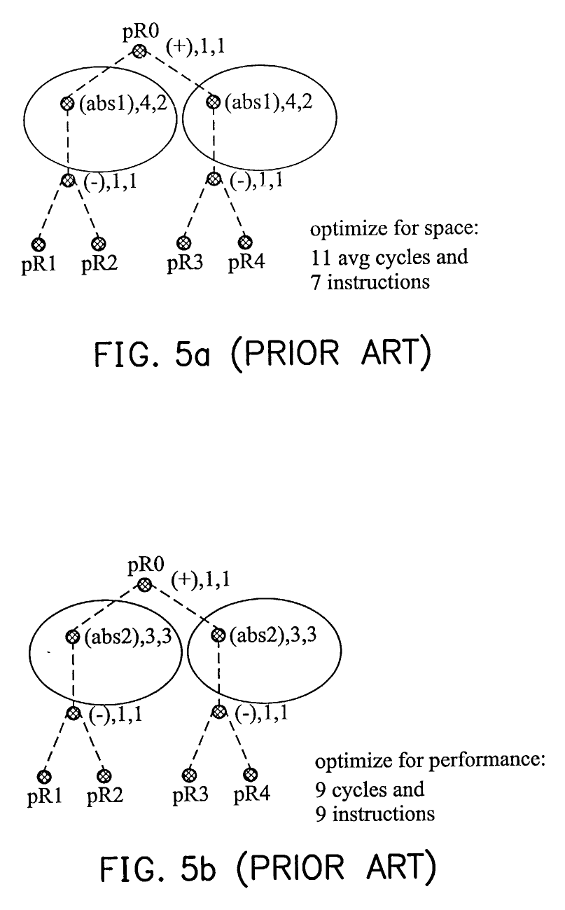

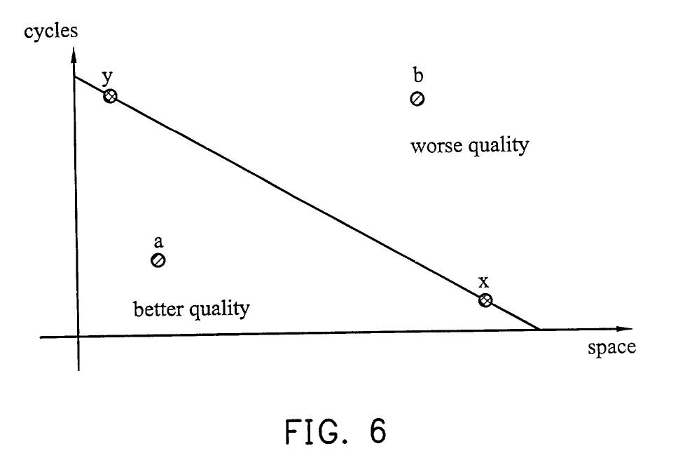

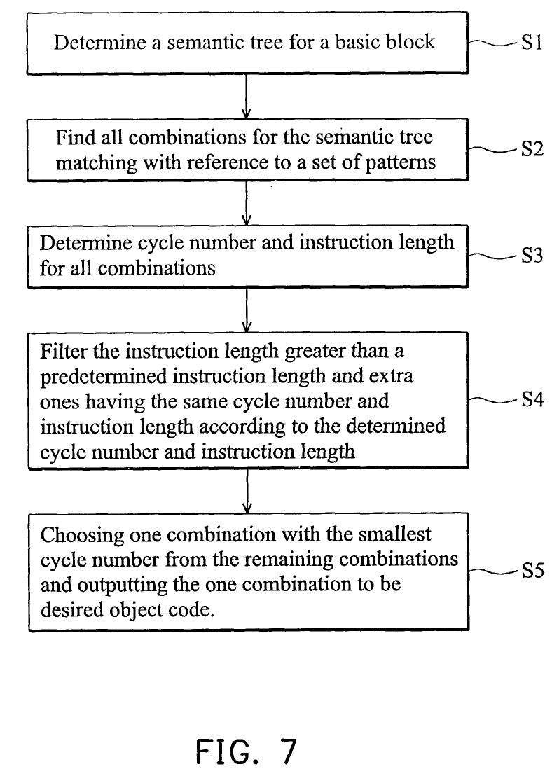

FIG. 7 is a flowchart of the method for improving instruction selection efficiency in a DSP/RISC compiler according to the invention. In FIG. 7, the method includes the following steps: determining a semantic tree for a basic block (S1); finding all matching combinations for the semantic tree with reference to a set of patterns (S2); determining cycle number and instruction length for all combinations (S3); filtering the instruction length greater than a predetermined instruction length and extra ones having the same cycle number and instruction length according to the determined cycle number and instruction length (S4); and choosing one combination with the smallest cycle number from the remaining combinations and outputting the one combination to be the desired object code (S5). As shown in FIG. 7, as comparison of the invention to the typical instruction selection, the latter has completed a semantic tree for its basic block without finding all possible combinations to determine the optimal space. For the same example (S1) mentioned above, according to the invention, the instruction selection algorithm is based on the identical example of FIG. 2.

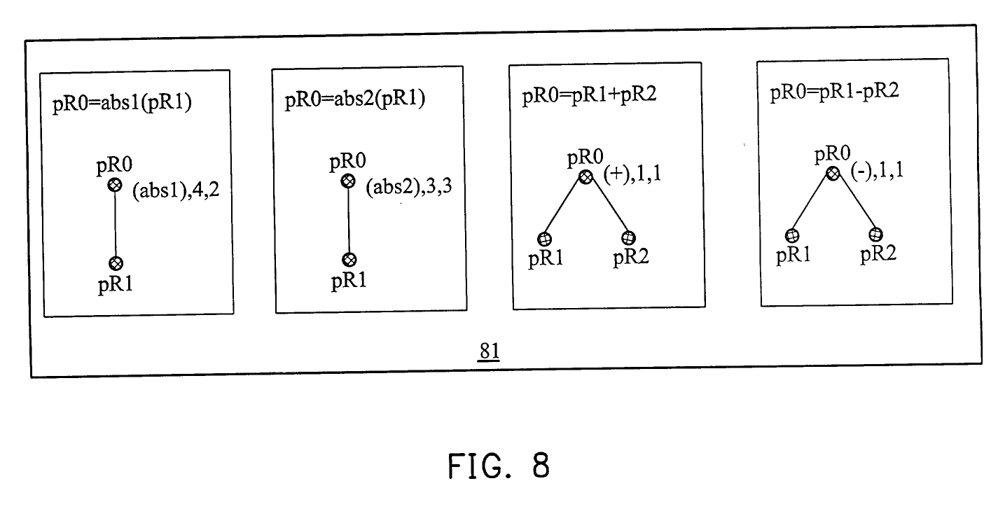

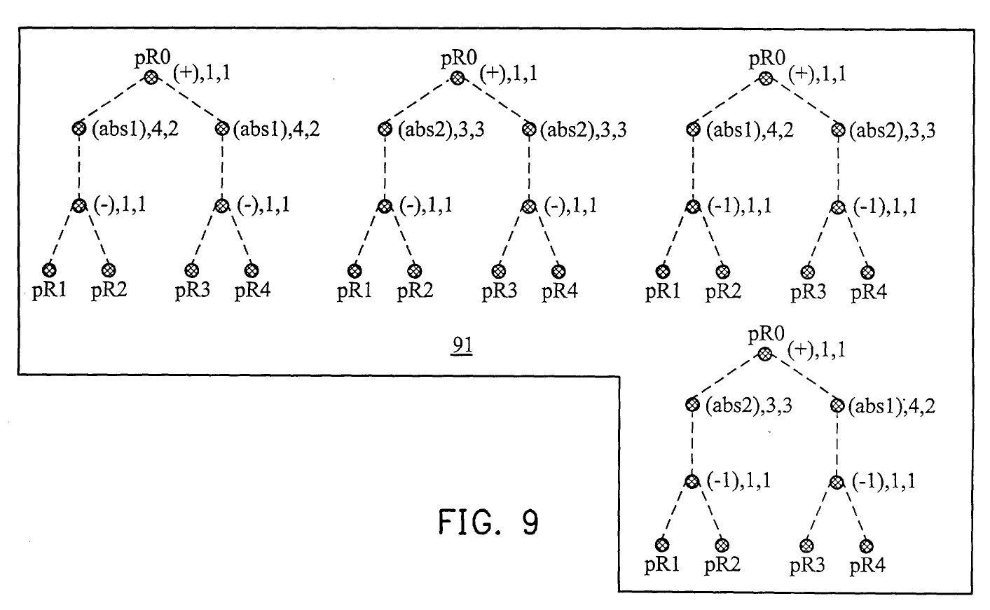

In step S2, a set of patterns is chosen. As shown in FIG. 8, the set of patterns 81 has 4 patterns with the content of node register pR0 respectively equal to abs1(pR1), abs2(pR1), pR1+pR2 and pR1−pR2. The notation such as (abs1), 4, 2 represents a first absolute operation absi needing 4 cycles and 2 instructions. Likely, the notation (abs2), 4, 2 represents a second absolute operation abs2 needing 4 cycles and 2 instructions. Further, a plus or minus operation needs 1 cycle and 1 instruction. In the prior case, only using the first or second absolute operation to complete the semantic tree is shown. However, according to the invention, implementation of the semantic tree can have four combinations 91 as shown in FIG. 9 (S2), respectively having 11 cycles and 7 instructions; 9 cycles and 9 instructions; 10 cycles and 8 instructions; and 10 cycles and 8 instructions (S3). Because the last two combinations have the same cycles and instructions, one (S4), for example the latest one, is omitted. By consideration of a predetermined instruction length limitation with 8 instructions, the second combination with 9 instructions is deleted (S4). Because the combination with an abs1 and an abs2 has 10 cycles smaller than another remaining one with 11 cycles, the combination with an abs1 and an abs2 is output as desired object code (S5).

The algorithm for execution of the cited processes is:

comp_C(v)
Cv=Φ
for all pεP,

if p can match v then [symbol]
=v+r1(p); [symbol] =v+r2(p);
for all C_{/1,i}εC_{/1} and all C_{/2,j}εC_{/2}

if size(C_{/1,i})+size(C_{/2,j})+size(p)≦s [symbol] ,then

Cᵥ=insert(Cᵥ,(p,size(C_{/1,i})+size(C_{/2,j})

+size(p),cycle(C_{/1,i})+cycle
(C_{/2,j})+cycle(p), [symbol] , [symbol] ));

return Cᵥ

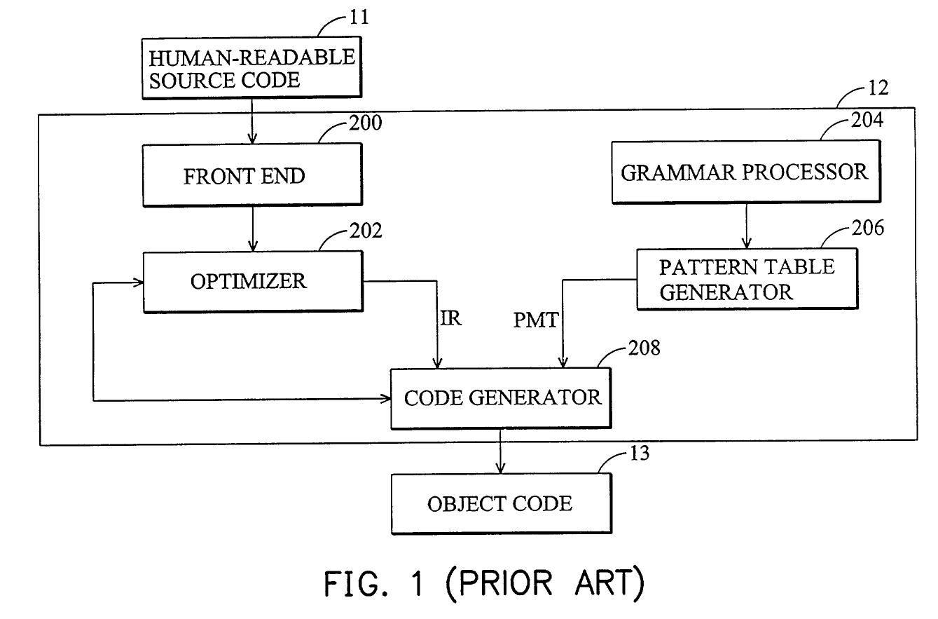

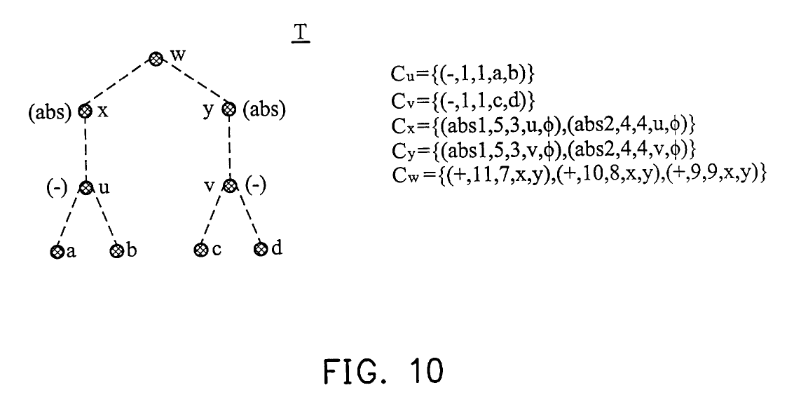

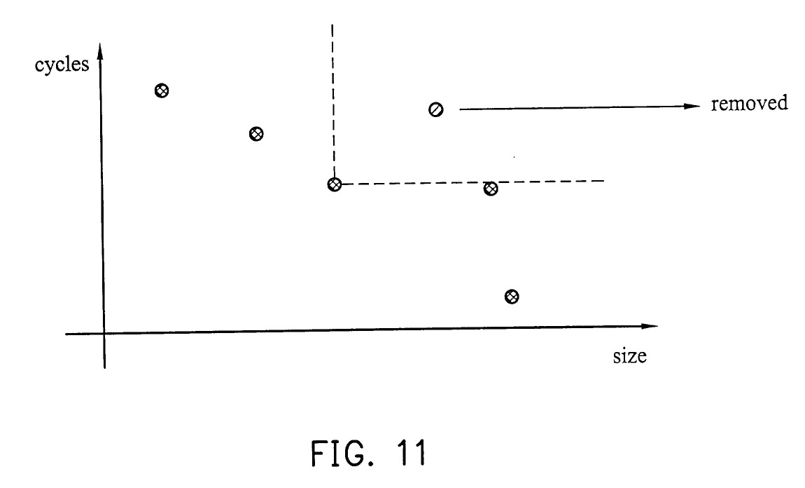

As cited, the procedure name is comp_C(v). Cv is a candidate set for every node v and is reset to be an empty set at the beginning. P is a predetermined set of patterns. p is a selected pattern. C_{/1, i} is ith element from pattern root to the latest left node in the set Cv and C_{/2, j} is jth element from pattern root to the latest right node in the set Cv. sl is a limited memory space. Let Cv,i=(pattern name (p), cycle number (cycle), instruction length (size), left operation node (l1), right operation node (l2)) wherein Cv, i indicates that the ith element in the set Cv is completed by taking n sizes and m cycles to combine left node l1 and right node l2 to complete the pattern p on the semantic tree. The way to achieve the set Cv may not be only a pattern. Therefore, when a vector on a node has a size ranging in the limited memory space sl (i.e., total instruction length of size(C_{/1,i})+size(C_{/2,j})+size(p)≦sk), the vector will be inserted into the candidate set Cv. The above algorithm (procedure) is performed recursively until the unique root r is completed. For example, as shown in FIG. 10, a semantic tree T with nodes u, v, x, y and w respectively have the possible instruction selection sets Cu={(−, 1, 1, a, b)}, Cv={(−, 1, 1, c, d)}, Cx={(abs1, 5, 3, u, Φ),(abs2, 4, 4, u, Φ)}, Cy={(abs1, 5, 3, v, Φ), (abs2, 4, 4, v, Φ)}, and Cw={(+, 11, 7, x, y)} (+, 10, 8, x, y), {(+, 9, 9, x, y)}. By the optimized instruction selection, as shown in FIG. 11, comparing all candidates in the root set Cw, under a region boundary (not a linear boundary as in the prior art), a path from the bottoms Cu={(−, 1, 1, a, b)} and Cv={(−, 1, 1, c, d)} to the root Cw={(+, 10, 8, x, y)} through Cx={(abs1, 5, 3, u, Φ)} and Cy={(abs2, 4, 4, v, Φ)} is output as the object code of the compiler (the same structure as shown in FIG. 1). Thus, we can achieve higher performance than in the prior art under the same memory size.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method for improving instruction selection efficiency in a DSP/RISC compiler, comprising the steps of:
determining a semantic tree for a basic block;
finding all matching combinations for the semantic tree with reference to a set of patterns;
determining cycle number and instruction length for all combinations;
filtering the instruction length greater than a predetermined instruction length and extra ones having the same cycle number and instruction length according to the determined cycle number and instruction length; and
choosing one combination with the smallest cycle number from the remaining combinations and outputting the one combination to be the desired object code.

2. The method of claim 1, wherein the basic block is represented as one or more independent data dependency graph, each including one or more nodes.

3. The method of claim 2, wherein each node represents an instruction.

4. The method of claim 1, wherein each of the patterns comprises an entry node at the top and a node connecting to the entry node.

5. The method of claim 1, wherein each of the patterns comprises an entry node at the top and multiple nodes connecting to the entry node.

6. The method of claim 1, wherein the set of patterns are machine-dependent.

7. The method of claim 1, wherein the instruction length is machine-dependent.

8. The method of claim 1, wherein the predetermined instruction length is determined by the capacity of the DSP/RISC compiler.

9. The method of claim 1, wherein the desired object code is an assembly code.

10. The method of claim 1, wherein the desired object code is a binary code.

11. The method of claim 1, wherein the semantic tree matching is executed from bottom to a single root where the basic block implementation is completed.

12. The method of claim 1, further comprising using an optimizer to implement the method.

13. The method of claim 1, further comprising using a code generator to execute the method to output the desired object code.
